(19) United States
(12) Patent Application Publication
(10) Pub. No.: US 2026/0365383 A1
(43) Pub. Date: Nov. 19, 2026

(54) FLOWABLE LIQUID SCRAPER

(71) Applicant: CHING-FU KUO, Taoyuan City (TW)

(72) Inventor: CHING-FU KUO, Taoyuan City (TW)

(21) Appl. No.: 19/146,898

(22) PCT Filed: Jul. 16, 2024
(86) PCT No.: PCT/CN2024/105613

§ 371 Date: Jul. 9, 2025

(30) Foreign Application Priority Data
Sep. 15, 2023 (CN) 202322510581.0

(51) Int. Cl. B65D 47/04

(52) U.S. Cl. CPC B65D 47/04

(57) ABSTRACT

The present invention provides a flowable liquid scraper including a socket, a liquid scraper ring and a sealing cover; where the socket is disposed on a liquid container, an accommodating groove is disposed in the middle of the socket, a bearing surface is formed at the bottom of the accommodating groove, the socket is provided with a through hole running vertically through the bearing surface, and a tube for extracting flowable liquid from the liquid container passes through the through hole; the liquid scraper ring is disposed in the accommodating groove, such that the tube passes through the liquid scraper ring to scrape off residual liquid on the surface of the tube while passing through the through hole; the sealing cover covers the accommodating groove above the liquid scraper ring in a fixed manner, such that an upper portion of the sealing cover is flush with an upper portion of the socket; and an upper end and a lower end of the liquid scraper ring are in contact the sealing cover and the bearing surface respectively, a positioning buckle and a positioning slot are disposed on contact surfaces between the liquid scraper ring and both the sealing cover and the bearing surface, such that the sealing cover presses the liquid scraper ring firmly against the bearing surface, and the buckle and the slot position the liquid scraper ring within the socket.

### BACKGROUND OF THE INVENTION

### 1. Field of the Invention

The present invention belongs to a flowable liquid scraper, and particularly relates to a flowable liquid scraper designed to scrape off residual liquid adhering to the surface of a liquid extraction tube after liquid extraction is completed, thereby maintaining workplace cleanliness and user safety while improving operational efficiency.

### 2. Description of the Prior Art

A common liquid extractor primarily includes a tube. During use, the tube is inserted into a container for liquid extraction; and after extraction is completed, the tube is pulled out, cleaned, and stored. This is a relatively simple procedure that can be easily performed by most people.

However, although the liquid extractor is not complicated in operation, there are still inconveniences during use, resulting in frequent trouble for users. The main problem is that the target extracted by the tube is a flowable liquid, which has certain fluidity and adhesiveness, and thus easily adheres to the surface of the tube. As the extractor is pulled out from the container, the flowable liquid adhering to the surface of the tube is also carried outside the container. In mild cases, this affects surface cleaning of the tube; and in severe cases, the flowable liquid may splash or spill onto the ground, causing floors of the workplace to be slippery and contaminated. This significantly adds the user's cleaning workload and affects the work procedure and efficiency. Furthermore, the slippery floors of the workplace caused by the flowable liquid may greatly add the risk of falls, posing hazards to personnel safety.

Therefore, when pulling out the tube, most users operate cautiously and slowly, and often use small containers, cloths, or paper towels to contain and wipe residual liquid from the tube surface, so as to minimize the chance of spillage. However, despite careful handling, accidental dripping or splattering of the flowable liquid may still occur, so that additional cleaning work is needed. Furthermore, using small containers, cloths, or paper towels to contain and absorb the flowable liquid not only increases waste volume of small containers, cloths, or paper towels, but also reduces the utilization rate of the flowable liquid itself, resulting in unnecessary waste.

Currently, there is a design of including a liquid scraper ring on the liquid container. When the tube is pulled out from the liquid container, the liquid scraper ring presses closely against the flowable liquid on the surface of the tube, helping to scrape off the flowable liquid and thereby reducing environmental pollution caused by the flowable liquid. However, as a simple annular component, the liquid scraper ring is prone to rotation, shifting, detachment, or breakage when subjected to frictional forces from the tube, leading to the failure of its function.

As can be seen, the liquid scraper ring in the related art has clear structural deficiencies, and its application scope is also relatively limited. Therefore, there is a need to make improvements to achieve better performance.

In view of the aforementioned shortcomings, the inventor began to carry out research & development and improvement to prevent flowable liquid or equivalent oil on the tube from spilling during extraction of flowable liquid or equivalent oil, thereby improving workplace cleanliness and user safety. After long-term research & development and practical implementation, the flowable liquid scraper is invented.

### SUMMARY OF THE INVENTION

An objective of the present invention is to provide a flowable liquid scraper with an optimized scraping structure. This design ensures that when the tube is pulled out from the container holding the flowable liquid, residual flowable liquid on the tube can be thoroughly and effectively scraped off; and meanwhile, it prevents dripping of residual flowable liquid when the flowable liquid extractor is put, thereby effectively maintaining workplace cleanliness and safety.

Another objective of the present invention is to provide a flowable liquid scraper with a robust, stable, and durable structure. This design can maintain the quality of residual flowable liquid that is scraped off during repeated friction and insertion/pullout of the tube, thereby ensuring smooth operation.

A still another objective of the present invention is to provide a flowable liquid scraper that is easy to assemble and convenient to maintain. This design achieves significant cost reduction over the long-term use while maintaining the function of preventing the flowable liquid from spilling.

To achieve the objectives described above, the technical solution adopted by the present invention is to provide a flowable liquid scraper including a socket, a liquid scraper ring and a sealing cover, where

the socket is disposed on a liquid container, an accommodating groove is disposed in the middle of the socket, a bearing surface is formed at the bottom of the accommodating groove, the socket is provided with a through hole running vertically through the bearing surface, and a tube for extracting flowable liquid from the liquid container passes through the through hole; the liquid scraper ring is disposed in the accommodating groove, such that the tube passes through the liquid scraper ring to scrape off residual liquid on the surface of the tube while passing through the through hole; the sealing cover covers the accommodating groove above the liquid scraper ring in a fixed manner, such that an upper portion of the sealing cover is flush with an upper portion of the socket; and an upper end and a lower end of the liquid scraper ring are in contact the sealing cover and the bearing surface respectively, a positioning buckle and a positioning slot are disposed on contact surfaces between the liquid scraper ring and both the sealing cover and the bearing surface, such that the sealing cover presses the liquid scraper ring firmly against the bearing surface, and the buckle and the slot position the liquid scraper ring within the socket.

In actual use, two or more liquid scraper rings are arranged at the same time, and a spacer is disposed between two adjacent liquid scraper rings. A surface of the spacer is provided with a corresponding slot or buckle to fit with the buckle or the slot of the liquid scraper ring.

In the above design, the buckle or the slot is arranged at the upper end and the lower end of the liquid scraper ring, and the fitting slot or buckle is simultaneously arranged on the sealing cover, the bearing surface, and the spacer.

Alternatively, a flange is disposed on the contact surfaces of the sealing cover, the bearing surface, and the spacer adjacent to both ends of the buckle, and the flange is made in contact with the liquid scraper ring adjacent to both ends of the buckle to strengthen the positioning effect.

Meanwhile, a wall surface of the accommodating groove is provided with a guide track, and a positioning edge is disposed on edges of the liquid scraper ring and the spacer, opposite to the guide track, such that the positioning edge accurately guides the liquid scraper ring and the spacer into the accommodating groove along the guide track.

In addition, the liquid scraper ring is provided with a fixation portion and a liquid scraper portion, and the liquid scraper portion is of a soft hollow sleeve-like structure, such that the liquid scraper portion detachably sleeves the fixation portion.

Moreover, the sealing cover is provided with countersunk holes, screws are inserted through the countersunk holes to secure the sealing cover onto the socket, and heads of the screws are concealed within the countersunk holes to maintain smoothness of an upper portion of the socket.

### BRIEF DESCRIPTION OF THE DRAWINGS

FIG. 1 is a structural three-dimensional view according to the present invention.

FIG. 2 is a structural three-dimensional exploded view according to the present invention.

FIG. 3 is a sectional view showing structural disassembly according to the present invention.

FIG. 4 is an enlarged view of a liquid scraper ring at position 3a in FIG. 3.

FIG. 5 is a sectional view showing structural assembly according to the present invention.

FIG. 6 is a structural three-dimensional exploded view showing arrangement of the second liquid scraper ring and the spacer according to the present invention.

FIG. 7 is an enlarged view of the liquid scraper ring at position 6a in FIG. 6.

FIG. 8 is an enlarged view of a spacer at position 6b in FIG. 6.

FIG. 9 is an enlarged view of a bearing surface at position 6c in FIG. 6.

FIG. 10 is a schematic diagram of an overall structure applied to the operation of extracting flowable liquid according to the present invention.

### Description Of Reference Numerals

100: socket
110: accommodating groove
120: bearing surface
130: through hole
140: bolt
200: liquid scraper ring
210: fixation portion
220: liquid scraper portion
300: sealing cover
310: countersunk hole
320: screw
400: flowable liquid container
500: flowable liquid extractor
510: tube
600: spacer
710: buckle
720: slot
740: flange
750: guide track
760: positioning edge

### DETAILED DESCRIPTION OF THE PREFERRED EMBODIMENTS

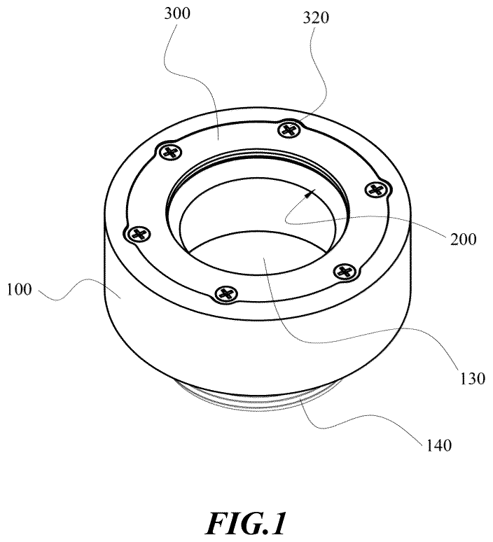

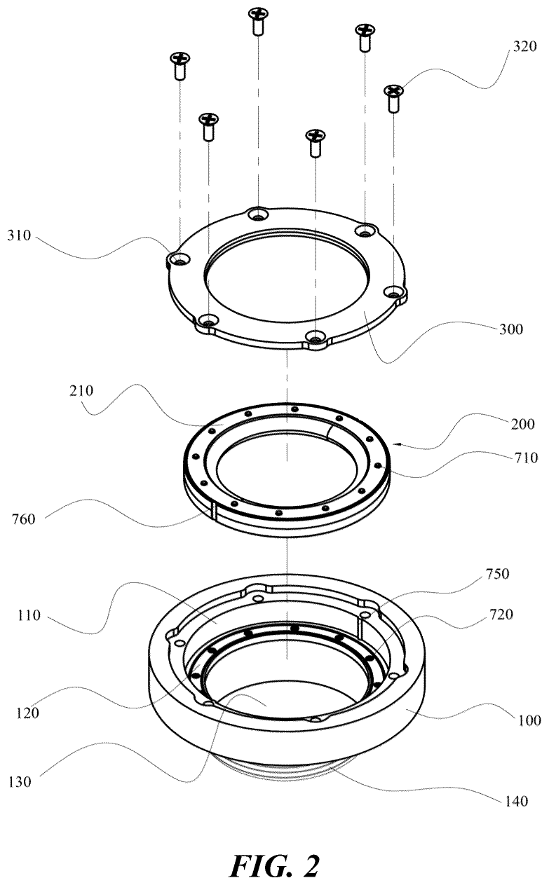

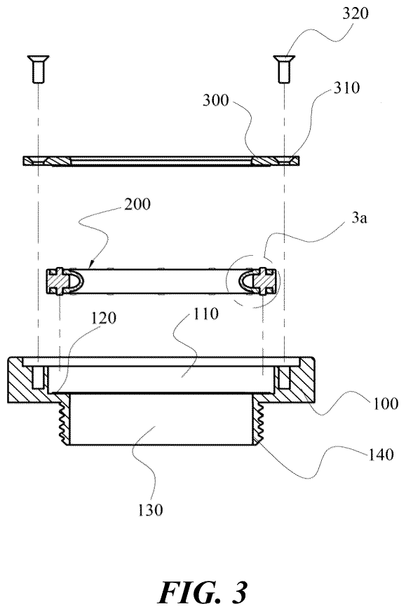

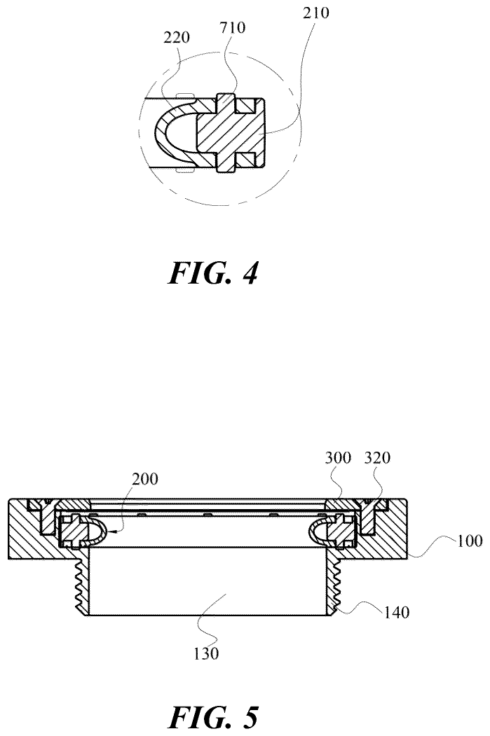

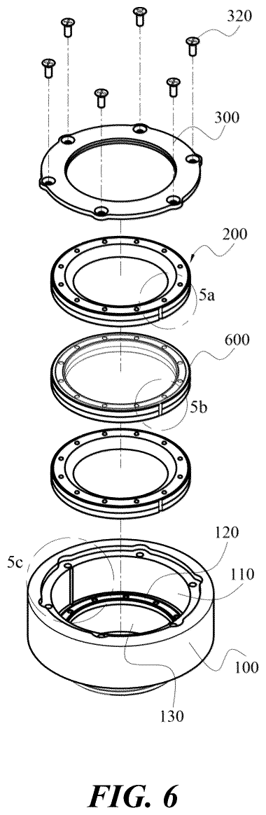

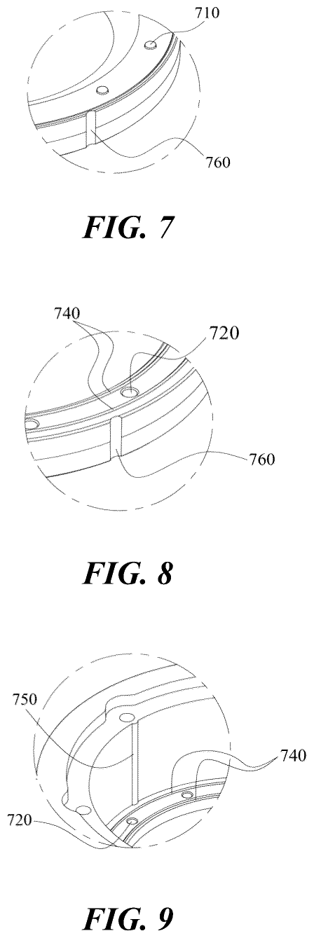

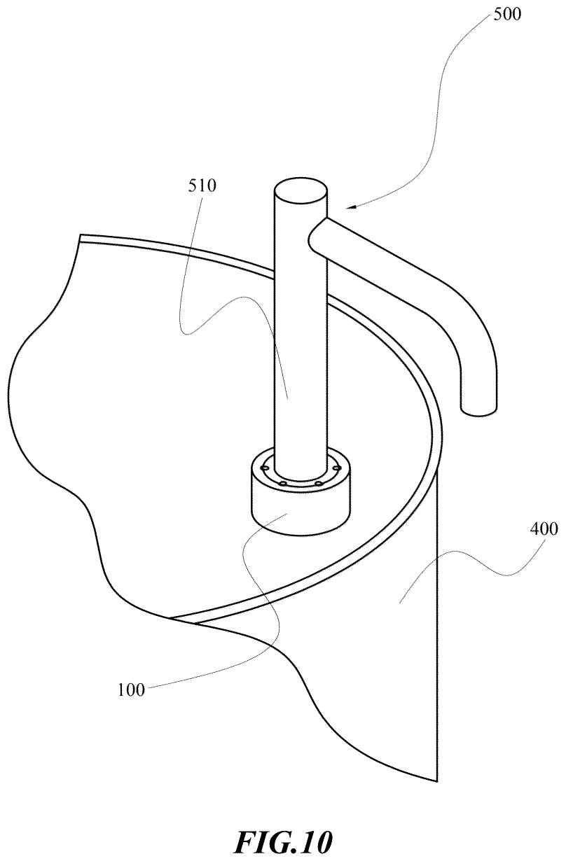

Referring to FIG. 1 to FIG. 10, a flowable liquid scraper is provided, mainly including a socket 100, a liquid scraper ring 200 and a sealing cover 300.

The socket 100 is disposed on a liquid container 400, flowable liquid is stored in the liquid container 400, an accommodating groove 110 is disposed in the middle of the socket 100, a bearing surface 120 is formed at the bottom of the accommodating groove 110, the socket 100 is provided with a through hole 130 running vertically through the bearing surface 120, and a tube 510 of a liquid extractor 500 passes through the through hole 130. The bottom of the socket 100 is provided with a bolt 140, and the socket 100 is secured onto an opening of the liquid container 400 by using the bolt. Then, the tube 510 is inserted through the through hole 130 into the liquid container 400, and the flowable liquid in the liquid container 400 is extracted by using the liquid extractor 500.

The liquid scraper ring is 200 disposed in the accommodating groove 110, with an inner edge of the liquid scraper ring protruding inward at the edge of the through hole 130. When the tube 510 passes through the through hole 130, the tube simultaneously passes through the liquid scraper ring 200, so that the inner edge of the liquid scraper ring 200 is pressed closely against the surface of the tube 510 to scrape off residual flowable liquid on the surface of the tube 510.

The sealing cover 300 covers the accommodating groove 110 above the liquid scraper ring 200 in a fixed manner, such that an upper portion of the sealing cover 300 is flush with an upper portion of the socket 100. By pressing the sealing cover 300 against the liquid scraper ring 200, fixation is achieved, so that when the tube 510 is inserted or pulled out, the liquid scraper ring 200 remains stable in position within the socket 100 without any vertical displacement or detachment, thereby maintaining the liquid scraping function.

The upper end and the lower end of the aforementioned liquid scraper ring 200 are in contact with the sealing cover 300 and the bearing surface 120, respectively. To securely fix the liquid scraper ring 200, buckles 710 are disposed at both ends of the liquid scraper ring 200, and the buckles 710 are arranged in a ring pattern on the surface of the liquid scraper ring 200. Correspondingly, slots 720 are disposed on the surface of the sealing cover 300 and the bearing surface 120, and the slots 720 are arranged opposite to the buckles 710. The buckles 710 and the slots 720 are used for positioning, and when the sealing cover 300 securely presses the liquid scraper ring 200 onto the bearing surface 120, the buckles 710 and the slots 720 engage with each other to position the liquid scraper ring 200 within the socket 100. In this way, the liquid scraper ring 200 is unlikely to rotate during use, thus preventing any interference with the liquid scraping function.

Given that the buckles 710 and the slots 720 fit with each other, reversely, the slots 720 can be disposed at both ends of the liquid scraper ring 200, and the buckles 710 can be disposed on the surfaces of the sealing cover 300 and the bearing surface 120. Alternatively, both ends of the liquid scraper ring 200 are provided with the buckle 710 and the slot 720, respectively, and the slot 720 and the buckle 710 are correspondingly arranged on the surfaces of the sealing cover 300 and the bearing surface 120 in a fitting manner.

Considering the effectiveness in use, two or more liquid scraper rings 200 are arranged simultaneously, and a spacer 600 is disposed between two adjacent liquid scraper rings 200. The surface of the spacer 600 is also provided with a corresponding slot 720 or buckle 710 to fit with the buckle 710 or the slot 720 of the liquid scraper ring 200. By using the spacer 600, the two liquid scraper rings 200 simultaneously go up and down to repeatedly scrape the surface of the tube 510, thus improving both work efficiency and quality.

In addition to the aforementioned positioning function achieved by the buckle 710 and the slot 720, another method for improving the positioning effect is also provided herein: a flange 740 is disposed on the contact surfaces of the sealing cover 300, the bearing surface 120, and the spacer 600 adjacent to both ends of the buckle 710, and the flange 740 is made in contact with the liquid scraper ring 200 adjacent to both ends of the buckle 710 to strengthen the positioning effect, so that the liquid scraper ring 200 does not shift during use, and the liquid scraping function is maintained. Certainly, the flange 740 can also be disposed at both ends of the liquid scraper ring 200 to be in contact with the sealing cover 300, the bearing surface 120, and the spacer 600, thereby achieving the same positioning function.

In addition, a wall surface of the accommodating groove 110 is provided with a guide track 750, and a positioning edge 760 is disposed on one side of the liquid scraper ring 200 and the spacer 600, opposite to the guide track 750, such that the positioning edge 760 accurately guides the liquid scraper ring 200 and the spacer 600 into the accommodating groove 110 along the guide track 750. On one hand, the accuracy and quality of assembling the product of the present invention are improved. On the other hand, the guide track 750 and the positioning edge 760 can also strengthen the positioning of the liquid scraper ring 200 and the spacer 600.

Furthermore, the liquid scraper ring 200 is provided with a fixation portion 210 and a liquid scraper portion 220, and the liquid scraper portion 220 is of a soft hollow sleeve-like structure, such that the liquid scraper portion 220 detachably sleeves the fixation portion 210. After the liquid scraper ring 200 has been used for a period of time, only the liquid scraper portion 220 needs to be replaced, which not only saves resources, but also reduces the amount of waste being produced.

Moreover, the sealing cover 300 is provided with countersunk holes 310, screws 320 are inserted through the countersunk holes 310 to secure the sealing cover 300 onto the socket 100, and heads of the screws 320 are concealed within the countersunk holes 310 to maintain smoothness of an upper portion of the socket 100.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A flowable liquid scraper, comprising:
a socket, wherein the socket is disposed on a liquid container, an accommodating groove is disposed in the middle of the socket, a bearing surface is formed at the bottom of the accommodating groove, the socket is provided with a through hole running vertically through the bearing surface, and a tube for extracting flowable liquid from the liquid container passes through the through hole;
a liquid scraper ring, wherein the liquid scraper ring is disposed in the accommodating groove, such that the tube passes through the liquid scraper ring to scrape off residual liquid on the surface of the tube while passing through the through hole;
a sealing cover, wherein the sealing cover covers the accommodating groove above the liquid scraper ring in a fixed manner, such that an upper portion of the sealing cover is flush with an upper portion of the socket; and
an upper end and a lower end of the liquid scraper ring are in contact the sealing cover and the bearing surface respectively, a positioning buckle and a positioning slot are disposed on contact surfaces between the liquid scraper ring and both the sealing cover and the bearing surface, such that the sealing cover presses the liquid scraper ring firmly against the bearing surface, and the buckle and the slot position the liquid scraper ring within the socket.

2. The flowable liquid scraper according to claim 1, wherein two or more liquid scraper rings are arranged at the same time, and a spacer is disposed between two adjacent liquid scraper rings, wherein a surface of the spacer is provided with a corresponding slot or buckle to fit with the buckle or the slot of the liquid scraper ring.

3. The flowable liquid scraper according to claim 2, wherein the buckle or the slot is arranged at the upper end and the lower end of the liquid scraper ring, and the fitting slot or buckle is simultaneously arranged on the sealing cover, the bearing surface, and the spacer.

4. The flowable liquid scraper according to claim 2, wherein a flange is disposed on contact surfaces of the sealing cover, the bearing surface, and the spacer adjacent to both ends of the buckle, and the flange is made in contact with the liquid scraper ring adjacent to both ends of the buckle to strengthen positioning effect.

5. The flowable liquid scraper according to claim 2, wherein a wall surface of the accommodating groove is provided with a guide track, and a positioning edge is disposed on edges of the liquid scraper ring and the spacer, opposite to the guide track, such that the positioning edge accurately guides the liquid scraper ring and the spacer into the accommodating groove along the guide track.

6. The flowable liquid scraper according to claim 1, wherein the liquid scraper ring is provided with a fixation portion and a liquid scraper portion, and the liquid scraper portion is of a soft hollow sleeve-like structure, such that the liquid scraper portion detachably sleeves the fixation portion.

7. The flowable liquid scraper according to claim 1, wherein the sealing cover is provided with countersunk holes, screws are inserted through the countersunk holes to secure the sealing cover onto the socket, and heads of the screws are concealed within the countersunk holes to maintain smoothness of an upper portion of the socket.
